(19) United States
(12) Patent Application Publication
(10) Pub. No.: US 2019/0283371 A1
(43) Pub. Date: Sep. 19, 2019

(54) MULTILAYER STRUCTURES AND METHODS OF MAKING THE SAME

(71) Applicant: SABIC GLOBAL TECHNOLOGIES B.V., Bergen op Zoom (NL)

(72) Inventors: Daniel Bande, Barcelona (ES); Tianhua Ding, Newburgh, IN (US); Cornelis Johannes Gerardus Maria Van Peer, Halsteren (NL); Pieter Jan Antoon Janssen, Rijsbergen (NL)

(21) Appl. No.: 16/318,317

(22) PCT Filed: Jul. 20, 2017
(86) PCT No.: PCT/IB2017/054408

§ 371 Date: Jan. 16, 2019

Related U.S. Application Data
(60) Provisional application No. 62/365,052, filed on Jul. 21, 2016.

(51) Int. Cl. B32B 27/08; B32B 7/12; G06F 3/041

(52) U.S. Cl. CPC B32B 27/08; B32B 7/12; G06F 3/0412; B32B 2250/42; B32B 2250/05; G06F 2203/04103; B32B 2307/7246; B32B 2457/208; B32B 2307/546; B32B 2307/738; B32B 2307/582

(57) ABSTRACT

In an embodiment, a multilayer structure can comprise: an outermost layer; a sensor; a multilayer substrate A located between the sensor and the outermost layer, the multilayer substrate, comprising greater than or equal to 16 polymer A layers, preferably 16 to 512 polymer A layers; and greater than or equal to 16 polymer B layers, preferably 16 to 512 polymer B layers; wherein the polymer A layers and the polymer B layers are present in a ratio of 1:4 to 4:1, preferably the ratio is 1:1; wherein the multilayer substrate has a transmission of greater than or equal to 70%, preferably greater than or equal to 75%, or greater than or equal to 80%; wherein the structure has a water vapor transmission rate of less than or equal to 10 g/cc/day, preferably less than or equal to 8 g/cc/day, or less than or equal to 5 g/cc/day, or less than or equal to 2 g/cc/day.

### BACKGROUND

A touch screen sensor is an input device normally layered on the top of an electronic visual display of an information processing system. A user can give input or control the information processing system through simple or multi-touch gestures by touching the screen with a special stylus and/or one or more fingers. Some touchscreens use ordinary or specially coated gloves to work while others use a special stylus/pen only. The user can use the touchscreen to react to what is displayed and to control how it is displayed; for example, zooming to increase the text size. The touchscreen enables the user to interact directly with what is displayed, rather than using a mouse, touchpad, or any other intermediate device. Touchscreens are common in devices such as vehicles, game consoles, personal computers, tablet computers, electronic voting machines, and smartphones. The popularity of smartphones, tablets, and many types of information appliances is driving the demand and acceptance of common touchscreens for portable and functional electronics. Touchscreens are also found in the medical field and in heavy industry, as well as for automated teller machines (ATMs), and kiosks such as museum displays or room automation, where keyboard and mouse systems do not allow a suitably intuitive, rapid, or accurate interaction by the user with the display's content.

The design and implementation of touch screen displays presents many technical challenges. For example, the electrical components of the display must be protected from external hazards. For example, protection from external chemicals, moisture, humidity, water vapor, oxygen, extreme temperatures, electromagnetic interference, vibrations, stretching, and deformation is required. Accordingly, conventional touch screens require protective covers, attachment components, and other additional components separate from the display itself. This prevents the seamless integration of such conventional touch screen displays into their environment. For example, conventional touch screen displays cannot be easily customized to fit a curved surface. There is also a limitation on aesthetic and stylistic possibilities for conventional touch screen displays.

Thus, there is a strong need to protect integrated electrical components from environmental hazards and to allow any surface to be transformed into a seamless user interface display. There is also a need for thermoformable layers and electronics.

### SUMMARY

Disclosed, in various embodiments, are multilayer structures.

In an embodiment, a multilayer structure can comprise: an outermost layer; a sensor; a multilayer substrate A located between the sensor and the outermost layer, the multilayer substrate A, comprising greater than or equal to 16 polymer A layers, preferably 16 to 512 polymer A layers; and greater than or equal to 16 polymer B layers, preferably 16 to 512 polymer B layers; wherein the polymer A layers and the polymer B layers are present in a ratio of 1:4 to 4:1, preferably the ratio is 1:1; wherein the multilayer substrate A has a transmission of greater than or equal to 70%, preferably greater than or equal to 75%, or greater than or equal to 80%; wherein the structure has a water vapor transmission rate of less than or equal to 10 g/cc/day, preferably less than or equal to 8 g/cc/day, or less than or equal to 5 g/cc/day, or less than or equal to 2 g/cc/day; and optionally wherein the multilayer structure is thermoformable.

These and other features and characteristics are more particularly described below.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a simplified schematic diagram representing a multilayer structure.

FIG. 2 is a simplified schematic diagram representing a method of making a multilayer substrate.

FIG. 3 is a schematic, blown-up, cross-sectional view of an embodiment of a touchscreen in a central stack display or dashboard having a single closed, homogenous surface.

FIG. 4 is an illustration of a portion of an embodiment of a prior art dashboard showing buttons and bezels.

FIG. 5 is an illustration of another embodiment of a touchscreen having a single, closed, homogenous surface.

FIG. 6 is an expanded, schematic illustration of an example of the layers of an illumination element and the method for forming that element.

FIG. 7 is a cross-sectional schematic illustration of another example of a touchscreen for a central stack display including in mold decoration and hard coat.

FIGS. 8A-8C are images obtained from a scanning electron microscope depicting multilayer substrates.

FIGS. 9A-9D are images obtained from a transmission electron microscope depicting multilayer substrates and comparative blended substrates.

### DETAILED DESCRIPTION

Addressed herein are issues related on how to protect inks (e.g., conductive inks) and electrical components with plastic layers resistant to chemicals, humidity, water and oxygen, EMC (electromagnetic compatibility (also known as electromagnetic interference (EMI) shielding), stretching, temperature, and vibrations. At least one of sensors, components, and electronics can be embedded in plastic layers. This allows for buttons replacement, touch screen sensor replacement, and material improvements (e.g., for homologation of the part for different industries such as automotive). The article would comprise a multilayer plastic substrate formed in a single coextruded process with two or more polymers, and at least one of coating layer(s), integrated sensor(s), in mold decoration, in mold electronics, and haptic feedback modules. This article could be used in a flat panel display (such as a liquid crystal display (LCD)), a field emission display (FED), a plasma display panel (PDP), an organic light emitting diode (OLED) display, and an electrophoresis display (EPD).

Surfaces using discrete electronic components and actuators require different tooling and assembly and additional steps for production and tuning. When integrating electronics in a smart surface, additional problems have to be addressed since reliability and quality of the part need to be warrantied. Protection of the electronics (e.g., with conductive layers for electromagnetic isolation) from emissions coming from displays and for isolation of emissions coming from integrated modules in the plastic layers is needed. EMC protection can reduce emissions coming from the display that potentially can affect other electronic devices of the car and to protect the display from radiated emissions coming from the exterior.

Currently touchscreen sensors use sensors mounted on the display and later a decorative cover is mounted on the display. The same principle applies for buttons, switches, and electronics for the illumination, these features need to be assembled to the plastic cover.

The combination of all functions in a 3D formed article (e.g., automotive console, a touch screen, and so forth) poses many technical challenges. One of the main technical challenges is an effective barrier function integrated into the final part. For example the application of a thermoformable barrier coating.

The multilayer structures disclosed herein can protect integrated electrical components from environmental hazards and allow any surface to be transformed into a seamless user interface display. For example, the multilayer structures can allow integration into the layers of the structure both electrical and non-electrical components such as touch sensors, image displays, microcontrollers, integrated circuits, conductive inks, adhesives, decorative components, electronic switches, buttons, and combinations comprising at least one of the foregoing. The integration of such components within the multilayer structure provides protection for the components from environmental hazards, e.g., hazards that occur during manufacturing as well as the hazards of everyday use. The multilayer structure can protect integrated components from one or more of: external chemicals, moisture, humidity, water vapor, oxygen, extreme temperatures, electromagnetic interference, vibrations, stretching, and deformation. For example, the multilayer structure disclosed herein can have a moisture vapor transmission rate of less than or equal to 1.6 grams per cubic meter per day (g/m³/day).

The multilayer structure can: (i) be used as a fully functional touch display interface, e.g., with a transmissivity of greater than or equal to 90% so as to allow viewing of internal display components; (ii) be thermoformable (e.g., at a temperature of 135° C. to 175° C., or 135° C. to 150° C.); (iii) allow easy integration of components and can be formed into custom shapes and designs to fit any application; and/or (iii) allow seamless integration of a touch screen display into the curved surfaces of a vehicle. Because the components are integrated and protected within the multilayer structure, no additional covers, barriers, or separate protection components are needed. Furthermore, the multilayer structure does not require any mechanical attachment to a surface, for example via screws, but rather can serve as both the surface itself and the touch display. This also allows for both easy conformity to industry standards and regulations and for enhanced aesthetics and desirability of the product.

The method disclosed herein for making a multilayer article comprises forming a multilayer substrate. Forming the multilayer substrate can include coextruding two or more feed streams in an overlapping manner to form a composite layer stream, e.g., feed streams comprising at least two different polymers, optionally 2-6 polymers, or 2-4 polymers. The feed streams can be coextruded using an extrusion cycle comprising splitting the composite layer stream into two or more sub-streams which can then be repositioned in an overlapping manner, followed by contacting the sub-streams (e.g., lamination). For example, contacting can comprise lamination. The extrusion cycle can be repeated until a total number of desired substrate layers is achieved. The total number of substrate layers can be represented by the formula X(Y^{N}), wherein X represents the number of feed streams, Y represents the number of sub-streams, and N represents a number of times the extrusion cycle is repeated. For example, the extrusion cycle can produce a multilayer substrate with polymer A layers and polymer B layers that overlap in an alternating manner and are present in a 1:4 to 4:1 ratio, preferably a 1:1 ratio. Such substrates can be formed using the layer multiplication technology and equipment commercially available from Nordson Extrusion Dies Industries LLC, Chippewa Falls, Wis.

The polymer A stream can comprise polycarbonate, polyimide (e.g. polyamideimide, polyetherimide, and so forth), polyarylate, polysulphone (e.g., polyethersulphone), poly alkyl methacrylate (e.g., polymethylmethacrylate, polybutyl methacrylate, and so forth), polyvinylidene fluoride, polyvinylchloride, acrylonitrile butadiene styrene polymers (ABS), acrylic-styrene-acrylonitrile polymers (ASA), acrylonitrile-ethylene-propylene-diene-styrene polymers (A-EPDM), polystyrene, polyphenylene sulfide, polyurethane, polyphenylene ether, or a combination comprising at least one of the foregoing. For example, the polymer A stream can comprise polycarbonate, polyetherimide, polysulphone, polymethylmethacrylate, polyvinylchloride, polyurethane, polyphenylene ether, or a combination comprising at least one of the foregoing, e.g., can comprise polycarbonate. For example, polymer A can be a polycarbonate copolymer such as polycarbonate-siloxane block copolymers (such as LEXAN™ EXL Resin). Another possible copolymer is polycarbonate and iso- and terephthalate esters of resorcinol (ITR) (such as LEXAN™ SLX Resin). Another possible copolymer is a polycarbonate and sebacic acid (such as LEXAN™ HFD Resin).

The polymer B stream has a different composition than the polymer A stream. The polymer B stream can comprise polyester (polybutylene terephthalate, polyethylene terephthalate, and so forth), polyvinylidene fluoride, polyaryletherketone (“PAEK”; e.g., polyether ether ketone (PEEK)), polytetrafluoroethylene, polyamide (e.g., polyamide 6,6, polyamide 11), polyphenylene sulphide, polyoxymethylene, polyolefin (e.g., polypropylene, polyethylene), polyurethane, or a combination comprising at least one of the foregoing. For example, polymer B can comprise polyester, preferably at least one of polybutylene terephthalate and polyethylene terephthalate, and more preferably polyethylene terephthalate.

The method disclosed herein for making a multilayer substrate can include contacting two or more feed streams in an overlapping manner forming a composite layer stream, e.g., within a feed block of a co-extrusion apparatus. The two or more feed streams can be overlaid vertically to form a composite layer stream. The composite layer stream can remain un-blended wherein the polymer A stream and the polymer B stream remain distinguishable within the composite layer stream.

The multilayer substrate can also be formed using an extrusion feedblock that enables multilayer arrangements. For example, extrusion feedblocks such as those commercially available from Cloeren Inc., Orange, Tex.

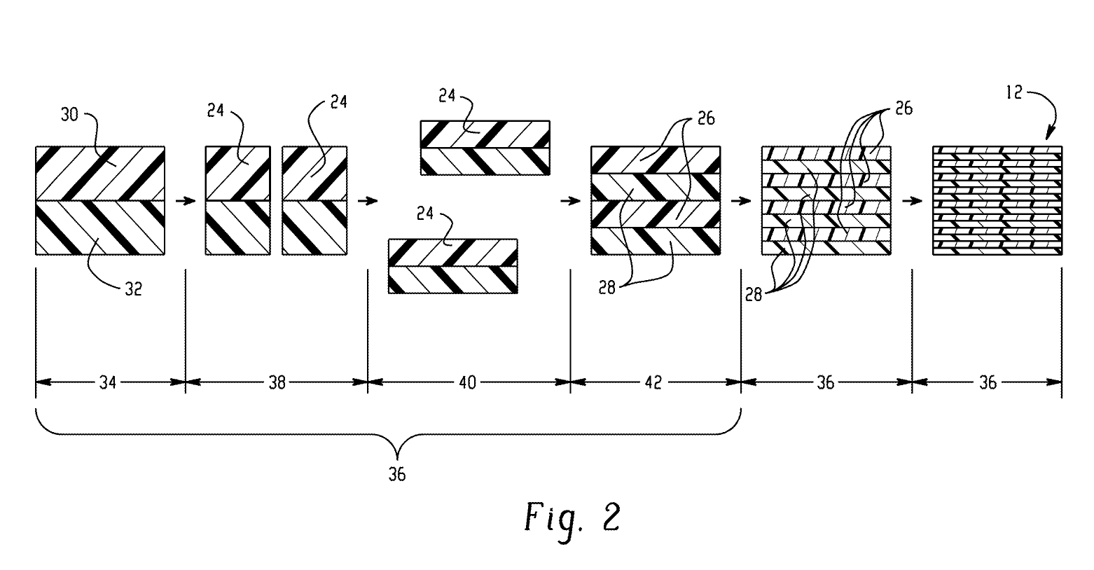

Once the composite layer stream is formed, it can be processed in an extrusion cycle comprising splitting the composite layer stream into two or more sub-streams. For example, the composite layer stream can be split vertically into two or more diverging sub-streams, wherein each sub-stream comprises at least a portion of each original feed stream. In other words, each sub-stream comprises a portion of all of the layers of the composite layer stream. The sub-streams can then be repositioned in an overlapping manner. For example, each sub-stream can travel through its own divergent channel within a co-extrusion apparatus which direct the sub-streams to an overlaid position (e.g., a vertically overlaid position) where the sub-streams contact one another to form a subsequent composite layer stream comprising both of the sub-streams aligned (e.g., vertically). (See FIG. 2) The extrusion cycle combines the two or more sub-streams. For example, the sub-streams are released from the vertically overlaid channels, thus contacting each other in an overlapping manner. The extrusion cycle can be repeated until a multilayer substrate having the desired number of layers is achieved. Once the multilayer substrate formation is complete, a skin layer can be applied to one or both sides of the substrate. Examples of such co-extrusion processes, systems, and techniques are disclosed in U.S. Pat. No. 4,426,344 to Dinter et al., U.S. Pat. No. 5,094,793 to Schrenk et al., and U.S. Publication No. 2005/0029691 to Cloeren.

The total number of substrate layers can be represented by the formula X(Y^{N}), wherein X represents the number of feed streams, Y represents the number of sub-streams, and N represents a number of times the extrusion cycle is repeated. For example, the extrusion cycle can produce a multilayer substrate with polymer A layers and polymer B layers that are distinguishable and overlap in an alternating manner.

The polymer A layers and the polymer B layer can be present within the multilayer substrate in a certain ratio. For example, polymer A layers and polymer B layers can be present in a ratio of 1:4 to 4:1, e.g., a ratio of 1:1, 1:3, or 3:1 ratio. The multilayer substrate can comprise a total number of layers of greater than or equal to 4 layers, for example, the total number of layers can be greater than or equal to 30 layers, greater than or equal to 64 layers, greater than or equal to 250 layers, and even greater than or equal to 512 layers. Optionally the number of layers can be 32 to 1024 layers, or 64 to 512 layers.

Optionally, the polymer A layers can comprise additive(s) such as stabilizer(s), colorants, dyes, anti-static agents, and so forth, with the proviso that the additive(s) are selected so as to not significantly adversely affect the desired properties of the composition. Polymer A layer can comprise additive(s) that undergo photo-chemical rearrangements to produce areas which interact with light differently (either visible light or non-visible light, e.g., UV active fluorescence) than the un-treated background, thereby forming a mark (text, logo, barcode, image, or the like). The additive can be a photoactive additive or colorant, which in certain media may be regarded as photochromic. For example, the polymer A layer can comprise less than or equal to 5 wt % whitening agent (e.g., titanium dioxide), e.g., 0.05 to 4 wt %, or 0.1 to 3 wt %, based upon a total weight of the polymer A layer. For example, the layer can comprise a laser marking additive that will form a mark when exposed to a laser. The type of laser marking additive and the type of laser are dependent upon the application and the desired mark.

Optionally, the polymer B layers can comprise additive(s) such as stabilizer(s), colorants, dyes, antistatic agents, and so forth, with the proviso that the additive(s) are selected so as to not significantly adversely affect the desired properties of the composition. Polymer B layer can comprise additive(s) that undergo photo-chemical rearrangements to produce areas which interact with light differently (either visible light or non-visible light, e.g., UV active fluorescence) than the un-treated background, thereby forming a mark (text, logo, barcode, image, or the like). The additive can be a photoactive additive or colorant, which in certain media may be regarded as photochromic. For example, the polymer B layer can comprise less than or equal to 5 wt % whitening agent (e.g., titanium dioxide), e.g., 0.05 to 4 wt %, or 0.1 to 3 wt %, based upon a total weight of the polymer B layer.

Some possible additives that can be employed in one or more of polymer A layer or polymer B layer include hydroxybenzophenones, hydroxybenzotriazoles, hydroxybenzotriazines, cyanoacrylates, oxanilides, benzoxazinones, benzylidene malonates, hindered amine light stabilizers, nano-scale inorganics, and combinations comprising at least one of the foregoing. Other examples of additives can include members of the spiropyran, spirooxazine, fulgide, diarylethene, spirodihydroindolizine, azo-compounds, and Schiff base, benzo- and naphthopyrans families, and combinations comprising at least one of the foregoing. Other possible additives include taggants, e.g., phosphors such as yttrium oxysulfide (europium-doped yttrium oxysulfide) and/or a nitride taggant material. For example, nitride material that is optionally doped with cerium and/or europium, a nitrido silicate, a nitride orthosilicate, an oxonitridoaluminosilicate, or a combination comprising at least one of the foregoing.

The multilayer substrate can have a total thickness based upon the application and requirements thereof. For example, the total thickness can be greater than or equal to 4 micrometers e.g., greater than or equal to 64 micrometers, such as 200 micrometers to 4,000 micrometers, 200 to 1,500 micrometers, or 250 to 550 micrometers. The total thickness of the multilayer substrate can be less than or equal to 1,000 micrometers, or could even be greater than 1,000 micrometers.

The thickness of an individual layer within the multilayer substrate is similarly based upon the specific application and desired properties of the substrate. Optionally, the thickness of an individual layer can be less than or equal to 15 micrometers, e.g., 0.1 to 10 micrometers, or 0.5 to 5 micrometers, or even 0.8 to 3 micrometers. It is noted that the thickness of the polymer A layer can be the same as the thickness of the polymer B layer. Alternatively, the thickness of the polymer A layer can be different than the thickness of the polymer B layer.

The multilayer substrate disclosed herein can have a flex-life of greater than or equal to 400,000 cycles, for example, greater than or equal to 500,000 cycles, even greater than or equal to 700,000 cycles. As used herein, flex-life cycles were determined according the standards found in ISO/IEC 24789-2:2011.

In addition to comprising the multilayer substrate(s), the multilayer structure can further comprise electrical and/or non-electrical components. The specific types of elements that are integrated with the multilayer substrate(s) is dependent upon the application. For example, whether the screen or button is capacitive, surface acoustic wave (SAW), and/or infrared LED or optical. Capacitive touchscreens include a substrate with a conductive layer (e.g., a metal oxide layer, such as an indium tin oxide layer). Touching the screen draws current (e.g. a minute amount of voltage), creating a voltage drop, and the coordinates of the point of contact (the point of a voltage drop) are calculated by a controller. SAW touchscreens comprise a layer over receiving and transmitting transducers. Here, electrical signals sent to the transmitting transducer convert to ultrasonic waves which are directed across the screen by reflectors that direct the waves to the receiving transducer. When the screen is touched, it absorbs waves. Values received by the receiving transducer are compared to stored digital maps to calculate the x and y coordinates. Finally, the infrared/optical touch screens use infrared LEDs and photodetectors. Touching the screen interrupts the LEDs. Cameras detect reflected LED caused by the touch, and controllers calculate coordinates from the camera data.

Therefore, a multilayer structure (e.g., a touchscreen display) can comprise at least one of light emitting diode(s) (LED), sensor(s) (e.g., switch(es)), controller(s) (e.g., microcontroller), camera(s), and/or transducer(s)), decorative layer(s) light adjusting layer(s) (e.g., diffusing layer(s), reflective layer(s)), EMC protection, actuator(s) (e.g., haptic feedback actuators), and so forth. It is clearly understood that the amount and location of each of these layers as well as the multilayer substrate(s) is dependent upon the specific application. The article can have a combination of decorative and functional properties. For example, printing can be used to apply decorative inks (e.g., for aesthetic reasons). Printing can be used to apply conductive inks, e.g., for electrical functionality, as desired. Optionally, coatings can be applied, e.g., to a surface comprising printing. For example, sensors can be applied by various processes (e.g., vapor deposition of the metals, printing, and so forth). The layer can then subsequently be laser patterned. A coating can also be applied to the outer surface of the article. The coating(s) and printed layer(s) can be up to 15 micrometers thick, e.g., 3 to 10 micrometers thick.

The sensors can optionally allow a user to interact directly with what is being displayed, e.g., rather than using buttons, a mouse, or a keyboard. Examples of sensors include field-effect sensor, proximity sensor, bulk mass sensor, triangulation sensors, capacitive type sensor, as well as other types of sensor, e.g., that can be touch sensors. Field-effect sensors allow controls to be isolated from direct contact with the operator and therefore can be placed behind protective surfaces. The field-effect sensors detect an operator's touch through a sealed protective surface without requiring mechanical movement of that surface.

The sensors can comprise electrically conductive traces (e.g., electrically conductive traces that have a transmission in the wavelength range of about 370 nm to 770 nm of greater than or equal to 30%, e.g., 30 to 95%, or 40 to 80%). As used herein, unless specifically stated otherwise, all transmission is determined in accordance with ASTM D1003-00, Procedure A, using D65 illumination, and 10 degrees observer. The traces can form an integrated circuit(s).

The traces can be formed from conductive inks, carbon nanotubes, conductive polymers, metal mesh, nanowires (e.g., metal nanowires), and combinations comprising at least one of the foregoing. The traces can comprise at least one of metal and metal oxide, e.g., in the form of particles having an average size of less than or equal to 3 micrometers (μm), specifically, less than or equal to 1 and even less than or equal to 0.1 in at least one dimension. The particles can have an average size of less than or equal to 3 specifically, less than or equal to 1 and even less than or equal to 0.1 in the largest dimension. Possible metals include at least one of silver, gold, platinum, palladium, nickel, cobalt, and copper. The metal can comprise silver, e.g., a silver alloy. Some possible silver alloys include silver-copper alloy and silver-palladium alloy. Examples of metal oxides include transparent conducting oxides, such as tin oxides and zinc oxides. For example, the metal oxide can be one or more of indium tin oxide (ITO), antimony-doped tin oxide (ATO), fluorine-doped tin oxide (FTO), aluminum-doped zinc oxide (AZO), and gallium doped zinc oxide (GZO); e.g., the metal oxide can comprise ITO.

The trace can comprise metal, e.g., a conductive polymer, such as, a metal composite (e.g., the metal can comprise silver, copper, or a combination comprising at least one of the foregoing) having a resistivity at 25° C. of less than or equal to 100 milliOhm/square/25 μm (mΩ/sq/25 μm). Desirably, the conductive polymer has a resistivity of less than or equal to 60 mΩ/sq/25 μm, for example, less than or equal to 45 mΩ/sq/25 μm, and even less than or equal to 25 mΩ/sq/25 μm. The conductive polymer can comprise at least one of thermoplastic, an elastomer, and thermosetting resin.

Between layers of the multilayer structure can be an optically transparent adhesive also known as an optically clear adhesive (OCA). The optically transparent adhesive has a transparency in the wavelength range of about 370 nm to 770 nm of greater than or equal to 60%, e.g., greater than or equal to 80%, or 80% to 100%, or 95 to 100%.

Optionally, between layers of the multilayer structure can be decorative layer(s); e.g., an in mold decorative layer. The decorative layer can comprise decorative ink(s) used for designs (e.g., symbols, pictures, text, aesthetics, and so forth). The decorative layers can comprise carbon fiber, high gloss black, high gloss white, and so forth. As used herein, “high gloss” is a gloss of greater than or equal to 90 as measured on an angle of 60 degrees according to ISO2813.

On an outermost surface of the multilayer structure can be a protective layer. This layer can be a hard coat layer or can have a hard coating thereon. Some examples of materials for the outermost layer include alkyl (meth)acrylates polymethylmethacrylate (PMMA),

Other possible layers include light adjusting layer(s). Light adjusting layer(s) include light collimating layers, diffusing layers, reflective layers, as well as combinations comprising at least one of the foregoing. Diffusing layer(s) can comprise surface texturing and/or diffusing particles such that the layer diffuses light that enters the layer. For example, the diffusing layer can have a degree of light dispersion at a thickness of 2.0 mm of greater than or equal to 15°, for example, greater than or equal to 25°, or greater than or equal to 40°, and even greater than or equal to 45°, wherein the degree of light dispersion measurements are performed on a Murakami GP 200. The diffusing layer can have a transmission, as measured on a 2.0 mm thick layer, of greater than or equal to 50%, for example, greater than or equal to 60%, and even greater than or equal to 75%; e.g., up to 90%.

Light collimating layer(s) collimate the light that enters the layer, e.g., such that light is concentrated and redirected toward a desired or target direction (e.g., on axis). Light collimating layer(s) comprise projections on the surface that redirect (or bend), and hence increase the amount of on axis light (e.g. collimates the light). The projections, e.g., surface texture, can be prismatic structures, cube corners, and so forth. Reflective layers are layers that reflect greater than or equal to 90% of the light in the wavelength range of about 370 nm to 770 nm, that is directed at the layer. Reflectivity percentage is determined with UV-VIS-VIS spectrophotometer, such as Perkin-Elmer Lambda 950, using 8 degrees angle setup. The reflective layer can comprise materials such as aluminum, silver, titanium dioxide, and combinations comprising at least one of the foregoing.

The multilayer structure disclosed herein can find use in a broad range of touchscreen display applications. For example, the multilayer substrate can be implemented into a vehicle, it can be used in a mobile device (e.g., cellular phone), a tablet, computer screen, as well as any other application employing a touchscreens, buttons, switches, or the like. For example, the multilayer substrate can function as an inner and/or outer surface of a display in a vehicle, such as replacing the radio switches and buttons, global positioning system (GPS) switches and buttons, and other similar elements of a vehicle dashboard. The multilayer substrate can be a curved surface.

The method of making the multilayer structure (also referred to as multilayer article; e.g. touchscreen, button, etc.), can comprise forming the multilayer substrate is described above. Disposing the sensor on a side of the multilayer substrate opposite the outermost layer (i.e., so that the multilayer substrate is between the outermost layer and the sensor). Disposing the sensor can comprise, for example, one or more of vapor deposition, printing, and laser patterning, the sensor or portions thereof on the multilayer substrate and/or on a polymer layer and locating the layer between the outermost layer and the multilayer substrate (multilayer substrate A). Optionally, a second multilayer substrate (multilayer substrate B), can be located between the outermost layer and the first multilayer substrate (multilayer substrate A). Once the desired layers are in place, the layers can be joined together. The layers can be joined together using at least one of molding (e.g., injection molding, injection compression molding, back molding, thermoforming, Niebling), and lamination. For example, the outmost layer and the multilayer substrate(s) and sensor(s) are placed in a mold, the mold is closed, and a thermoplastic material is injected into the mold, encapsulating the sensor and any other electronics, and forming the layers into the desired shape. In another example, the layers are arranged accordingly, e.g., outermost layer, optional decorative layer, multilayer substrate (multilayer substrate A), sensor layer (sensor layer SA), optional optically clear adhesive layer (optically clear adhesive layer OA), optional additional multilayer substrate (multilayer substrate B), optional additional sensor layer (sensor layer SB), optional additional optically clear adhesive layer (optically clear adhesive layer OB), optional diffuser layer, optional LED and traces, optional reflective layer, and optional haptic feedback actuator. Adjacent to the diffuser layer/LED/reflective layer, can be the display, which is in optical communication with the LED during use. The layers are then laminated together under pressure and optionally increased temperature.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

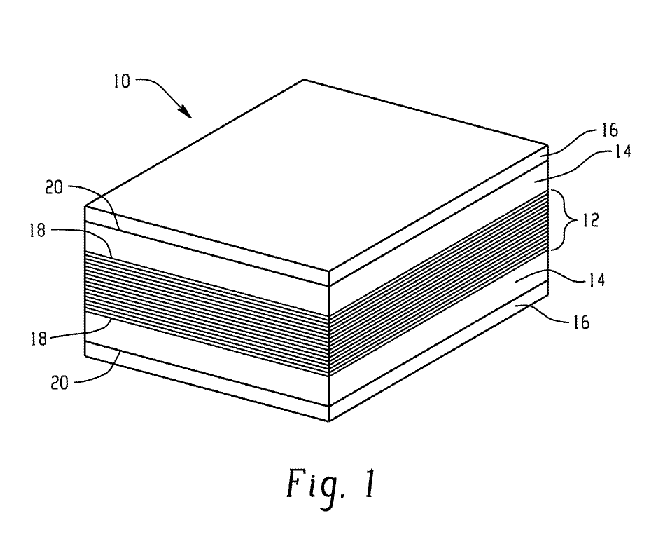

Referring now to FIG. 1, the multilayer identity card 10 disclosed herein can comprise a multilayer substrate 12. An information layer 14 can be located between the substrate 12 and a protection layer (transparent layer 16). For example, the information layer 14 can be located on a surface 18 of the multilayer substrate 12, while the transparent layer 16 can be located on a surface 20 of the information display layer 14.

Referring now to FIG. 2, the method of making a multilayer substrate 12 is illustrated. In this method, two or more feed streams (30,32) are contacted in an overlapping manner to form a composite layer stream 34. For example, FIG. 2 depicts two feed streams, polymer A stream 30 and polymer B stream 32, which can be contacted in an overlapping manner to form the composite layer stream 34. The two or more feed streams can be simultaneously extruded. Then, in extrusion cycle 36, the composite layer stream 34 is split 38 into two or more sub-streams 24 which are repositioned 40 in an overlapping manner, and recombined to form a single stream 42. The splitting and repositioning is repeated in as many further extrusion cycles 36 as desired until a desired total number of substrate layers is achieved.

The total number of substrate layers can be represented by the formula X(Y^{N}), wherein X represents the number of feed streams, Y represents the number of sub-streams, and N represents a number of times the extrusion cycle is repeated. For example, FIG. 2 depicts two feed streams 30 and 32, two sub-streams 24, three extrusion cycles 36, and a final multilayer substrate 12 with 16 total layers. For example, FIG. 2 depicts polymer A layers 26 and polymer B layer 28 that overlap in an alternating manner and are present in a 1:1 ratio.

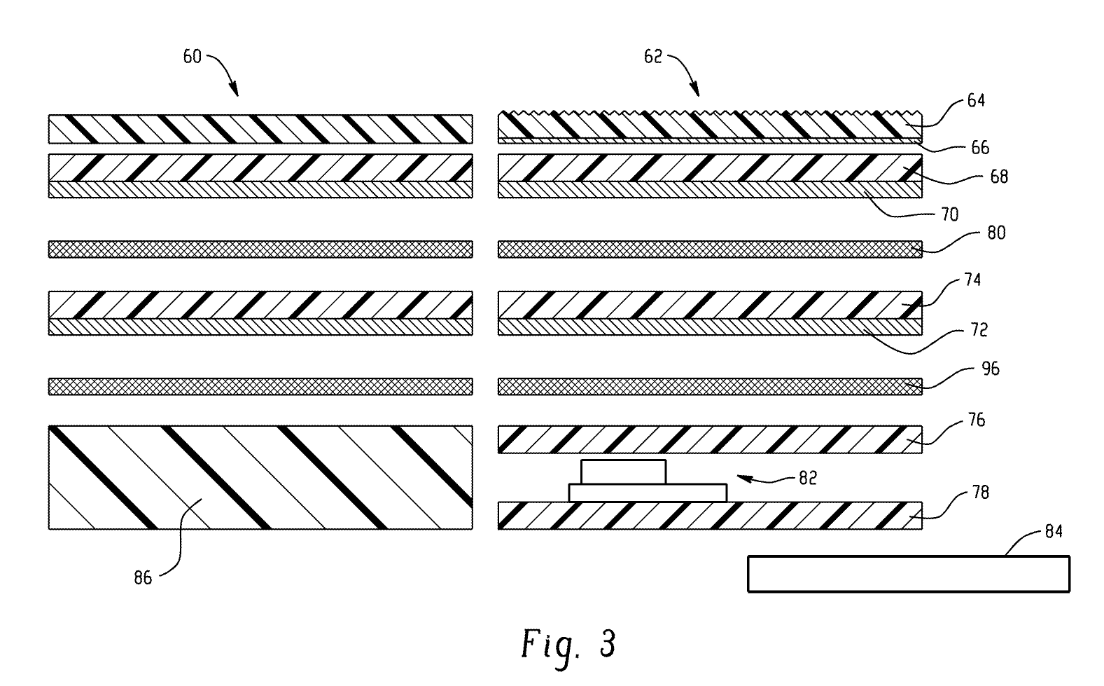

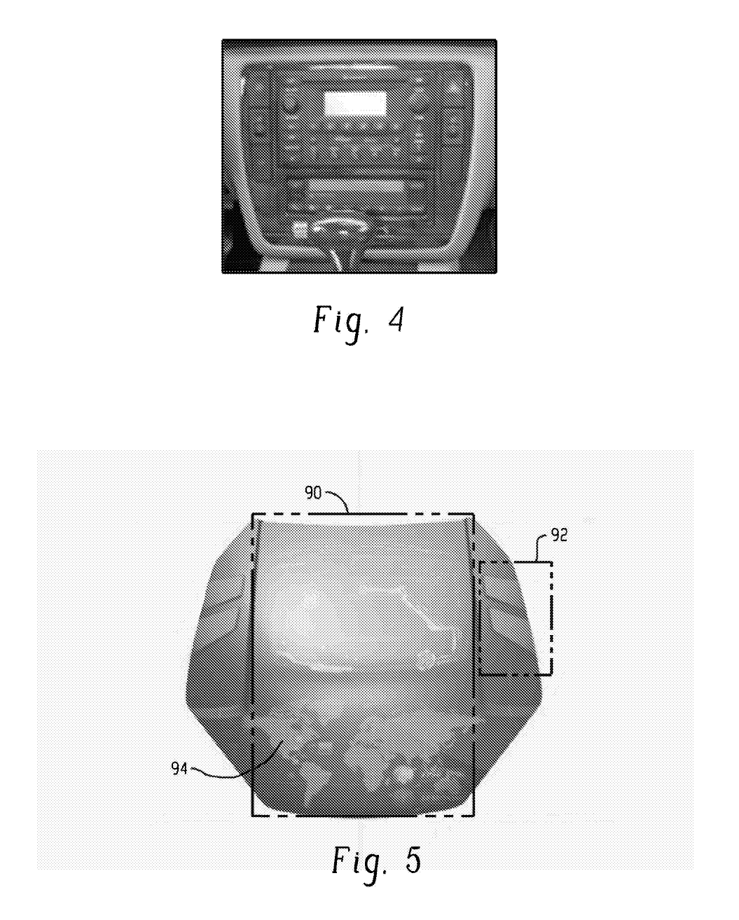

FIG. 3 is a cross-sectional schematic view of a possible touchscreen display. The touchscreen comprises a viewing area 60 (e.g., area 90 from FIG. 5), and a lateral area 62 (e.g., adjacent to area 90 in FIG. 5). Viewing area 60 is a single, closed, homogenous surface. The layers of the touchscreen display include sensor(s), multilayer substrate(s), and adhesive(s). For example, the touchscreen display can comprise: an outermost layer 64, decorative layer 66, plastic layer PA 68 (e.g., multilayer substrate A, or monolithic plastic layer A), sensor array SA 70, optically transparent adhesive (OCA) OA 80, plastic layer PB 74 (e.g., multilayer substrate PB, or monolithic plastic layer PB), sensor array SB 72, optically transparent adhesive OB 96, diffusor layer 76, LED with conductive traces 82, reflective layer 78, haptic feedback actuator 84, and display 86. In other words, one or more (e.g., two) multilayer substrates can be located between electronics (e.g., and LED and conductive traces), and one or more sensors. The outer surface comprises a protective layer (e.g., a coating) that is abrasion resistant. Between the coating and the multilayer substrate can be an optional decorative layer 66. Optionally, a bezel (not shown) can be located around the display area. On a side of the multilayer substrate opposite the protective layer (also referred to as the outermost layer), can be sensor(s).

FIG. 5 illustrates a central stack display with touchscreen sensor that integrates GPS, radio, entertainment system, and so forth. The touchscreen comprises a touch sensor area 90 and capacitive switches 92. As is illustrated in FIG. 5, various one or more of color effects and texture can be used to distinguish areas of the screen. For example, they can be used to identify the location of capacitive switches 92, e.g., which look like buttons. One or more of color effects and texture can provide aesthetic features (e.g., area 94, separating the viewing area).

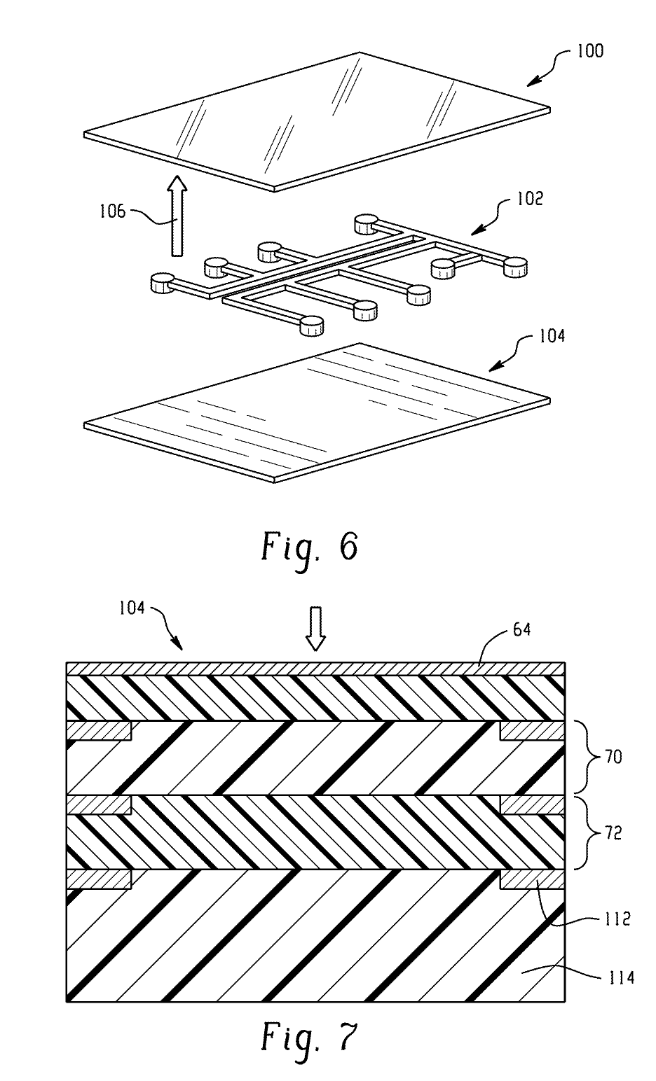

FIG. 6 integrates encapsulated electronics, surface mounted devices (SMD), printed electronics, and a multilayer substrate. In FIG. 6, the layers for the button are illustrated. Between layer 100 and the substrate 104 are printed electronics and SMD 102. Either or both of the layer 100 and the substrate 104 can be a multilayer substrate. For example, the substrate 104 can be a multilayer substrate. As is illustrated by the arrow 106, this structure can be injection molded to form the button.

FIG. 7 illustrates a cross-sectional view of a touchscreen. The outermost layer 64 has the touch surface. The following layers comprise two sensor layers 70,72, with traces (e.g. silver traces) 112 located between the sensor layers and the substrate 114. At least one of layers 70, 72, and 114 can be a multilayer substrate. For example, substrate 114 can be a multilayer substrate. Layer 70 can be a multilayer substrate. Layer 72 can be a multilayer substrate.

The following examples are merely illustrative of the multilayer identity articles disclosed herein and are not intended to limit the scope hereof.

### EXAMPLES

TABLE 1
Material Description

| Component | Description | Source |
|---|---|---|
| PC₁ | Polycarbonate resin (M_{w} = 18,000 g/mol, PS | SABIC |
| | standards) (LEXAN ™ Resin OQ1026) | |
| PC₂ | Polycarbonate resin (M_{w} = 21,800 g/mol, PS | SABIC |
| | standards) (LEXAN ™ Resin HF1110) | |
| PBT | Polybutylene terephthalate resin (M_{w} = | SABIC |
| | 111,000 g/mol, PS standards) (VALOX ™ 315) | |
| PET | Polyethylene terephthalate resin (ARNITE ™ | DSM |
| | A02 307 PET) | |
| Phosphoric | H₃O₄P (M_{w} = 98 g/mol, PS standards) | |
| Acid | | |
| Ruthenium | RuO₄ (M_{w} = 165.07 g/mol, PS standards) | |
| Tetroxide | | |

PS = polystyrene

### Example 1

Comparative samples 1-3 were prepared by conventional methods. PC₁ and PBT were separately compounded at 260° C., 300 rotations per minute (rpm), 15 kilograms per hour (kg/hr) throughput, and a torque of 42%. Subsequently, these pre-made blends were extruded into 500 micrometer thick film on a Dr. Collin film extrusion apparatus. A chill-roll setup was used at a temperature of 60° C. to collect the extruded films. 0.05 weight percent (wt. %) phosphoric acid was added during the compounding step to prevent potential resin degradation. Sample 3 was further press-polished to reduce surface roughness. A description of the materials used is provided in Table 1. Fatigue tests were conducted on the resulting monolayer extruded films according to the testing methods described in ISO/IEC 10373-1:2006 and ISO/IEC 10373-2:2006. Flex-life cycles were determined according the standards found in ISO/IEC 24789-2:2011. The results are provided in Table 2.

Samples 4-7 were prepared wherein the layers were split and repositioned until the desired number of layers was attained. The multi-layered sheets were prepared by simultaneous co-extrusion. A total of 5 or 8 extrusion cycles (N) were used to obtain respectively 64 or 512 alternating layers. A 25 centimeter (cm) wide die system with a varying gage was used to prepare 250 to 500 micrometer thick films. Samples 4 and 7 were prepared with a 1:1 ratio of PC₁ layers to PBT layer. Samples 5 and 6 were prepared using a 1:3 ratio and a 3:1 ratio respectively. A chill-roll setup at a temperature of 60° C. was used to collect the extruded films. Fatigue tests were conducted on the resulting extruded films according to the testing methods described in ISO/IEC 10373-1:2006 and IS O/IEC 10373-2:2006. Flex-life cycles were determined according the standards found in ISO/IEC 24789-2:2011. The results are provided in Table 2.

TABLE 2

| | | Thickness | Flex-life |
|---|---|---|---|
| Sample | Description | (micrometers) | Cycles |
| 1 | Monolayer PC₁ | 290 | 150,000 |
| 2 | Monolayer PC₁ | 546 | <10,000 |
| 3 | Monolayer PC₁ (press-polished) | 500 | <10,000 |
| 4 | 64 multilayer 1:1 PC₁/PBT | 249 | DNF* |
| 5 | 64 multilayer 1:3 PC₁/PBT | 257 | DNF* |
| 6 | 64 multilayer 3:1 PC₁/PBT | 283 | DNF* |
| 7 | 512 multilayer 1:1 PC₁/PBT | 500 | DNF* |

*DNF is did not fail; tested for 1 million flex-life cycles.

Table 2 demonstrates the unique performance and unexpected advantages of PC₁/PBT multilayer systems (Samples 4-7) as compared to the conventional PC₁ monolayer systems (Samples 1 to 3). For example, it is commonly known that flex-life improves when sample thickness is reduced. This is evident when comparing Sample 1 to Samples 2 and 3. This comparison shows a significant reduction in flex-life due to increased thickness from less than 300 micrometers to greater than 500 micrometers. Sample 3 demonstrates that surface roughness does not influence flex-life significantly, as the flex-life remained low (less than 10,000 cycles) after press-polishing. Samples 4 to 7 however, unexpectedly show that the flex-life of the multilayer systems was dramatically increased to greater than 200,000 cycles, even at a film thickness of 500 micrometers. It is noted that tests were stopped after 250,000 cycles for Samples 4-6 and after 200,000 cycles for Sample 7 as no indication of failure was observed whatsoever.

### Example 3

For the purposes of this example, two extruded films were subsequently laminated together, thus doubling their thickness. For example, Sample 8 was prepared by laminating two of the multilayer Sample 7 extruded films together. Sample 10 was prepared by laminating two monolayer Sample 9 extruded films together for comparative purposes. The samples were laminated in a Lauffer 40-70/2 lamination press using a default lamination method. The press was preheated to 200° C. and sheets were inserted into the press. The press was held for 20 minutes at 200° C. and 90 Newton per centimeter squared (N/cm²). The press was then cooled down to 20° C. and 205 N/cm². The total process time was approximately 40 minutes. After the samples were laminated, they were die cut into the shape of an identity card according to the standard presented in ISO/IEC 7810:2003. An Oasys OMP 100 punch unit was used. Fatigue tests were conducted on the resulting cards according to the testing methods described in ISO/IEC 10373-1:2006 and IS O/IEC 10373-2:2006. Flex-life cycles were determined according the standards found in ISO/IEC 24789-2:2011. The results are provided in Table 3.

TABLE 3

| | | Thickness | Flex-life |
|---|---|---|---|
| Sample | Description | (micrometers) | Cycles |
| 7 | 512 multilayer 1:1 PC₁/PBT | 500 | DNF* |
| 8 | 2 × (512 multilayer 1:1 PC₁/PBT) | 1000 | 200,000 |
| 9 | Monolayer 1:1 PC₁/PBT | 500 | DNF* |
| 10 | 2 × (Monolayer 1:1 PC₁/PBT) | 1000 | 40,000 |

*DNF is did not fail; tested for 1 million flex-life cycles.

Table 3 demonstrates the unique performance and unexpected advantages of laminated PC₁/PBT multilayer films, as compared to conventional monolayer laminated PC i/PBT blends. Although the monolayer blends of PC i/PBT (Sample 9) show improved flex-life as compared to the monolayer PC₁ films (Samples 1-3), the flex-life after a lamination step is reduced to a mere 40,000 cycles. By contrast, the 512 multilayer system maintains excellent flex-life (greater than 200,000 cycles) even with the inclusion of a lamination step. The flex-life test was stopped for Samples 7 and 8 after 200,000 cycles as no indication of failure was observed whatsoever.

### Example 4

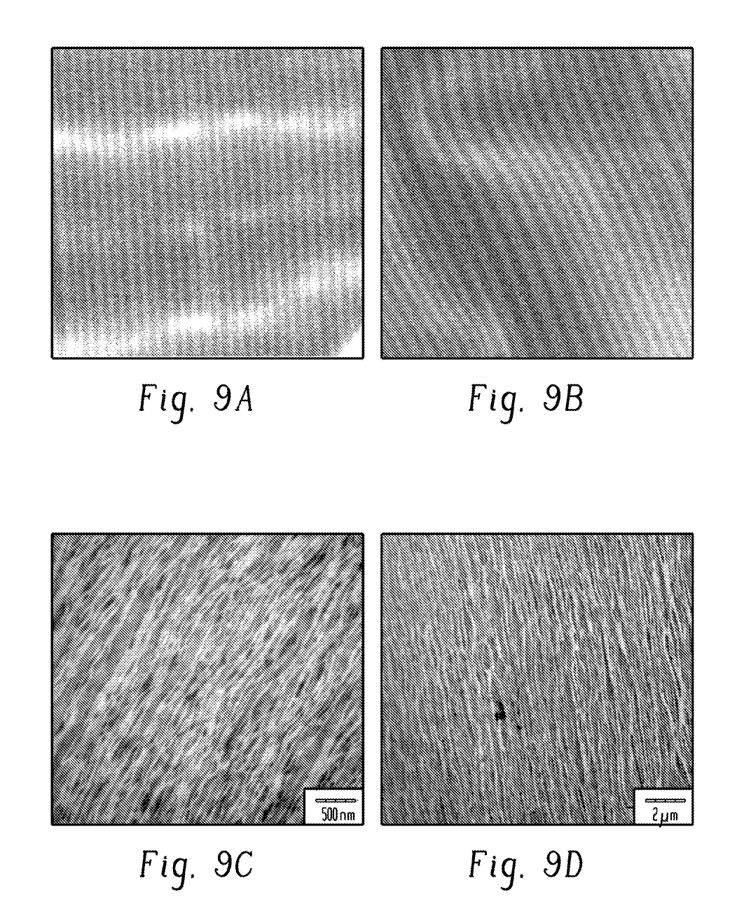

Samples 4-6 were subjected to Scanning Electron Microscopy (SEM). The samples were microtomed at room temperature and stained for 4 hours with ruthenium tetroxide. Images were taken on an ESEM XL30 at 10 kilovolts (kV), spot 4. The results are provided in FIGS. 9A-9C.

Samples 7-10 were subjected to Transmission Electron Microscopy (TEM). The samples were microtomed at room temperature and stained for 6.5 minutes with ruthenium tetroxide. Images were taken on a TEM Technai 12 at 100 kV, spot 1. The results are provided in FIGS. 9A-9D.

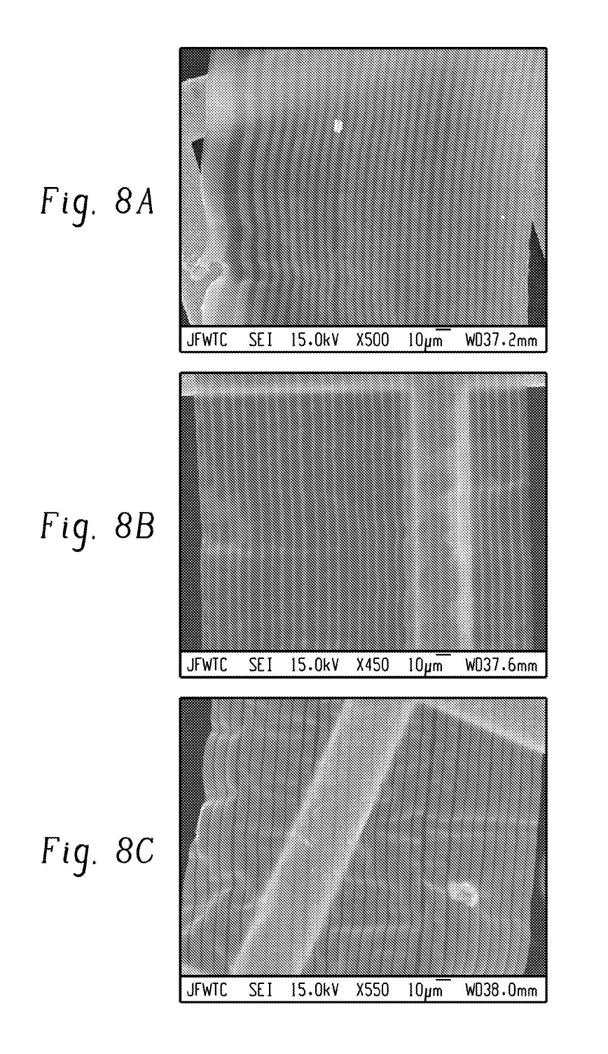

FIGS. 8A-8C (Samples 4-6) show a cross-section of multilayer substrate positioned on a copper grid, clearly depicting 64 alternating PC₁/PBT layers (PBT dark, PC₁ light). FIG. 9A (Sample 7) shows 512 alternating PC/PBT layers. FIG. 9B (Sample 8) demonstrates that even after intensive lamination, the multilayer substrate remains intact. FIGS. 9C-9D (Samples 9-10) show representative morphology images of the 1:1 PC₁/PBT conventional blend, exhibiting no distinct layers.

### Example 5

Flex-life is influenced by the molar mass of the resin used. Accordingly, it is important to exclude molar mass differences in the samples studied. Table 4 shows the number-average (Mn) and weight-average (Mw) molar mass of PC₁ and PBT in the extruded films. Table 5 demonstrates that there are no significant differences in the molar mass.

TABLE 4

| | | | PBT | |
|---|---|---|---|---|
| | PC Mn | PC Mw | Mn | PBT Mw |
| Sample | (g/mol) | (g/mol) | (g/mol) | (g/mol) |
| PBT | | | 36,900 | 110,100 |
| PC₁ | 8,200 | 18,000 | | |
| Sample 8 | 7,800 | 17,200 | 37,800 | 110,100 |
| Sample 9 | 8,300 | 18,300 | 38,900 | 113,000 |
| Sample 10 | 8,400 | 18,400 | 38,700 | 112,700 |

### Example 6

Flex-life may also be influenced by the crystallinity of the resin used. Differential Scanning calorimetry (DSC) measurements were carried out from 20° C. to 300° C. with a heating and cooling rate of 20° C. per minute. The first heating and cooling curves were used to determine the maximum melting endotherm (Tm,max), heat of fusion (ΔH) in joules per gram (J/g), and crystallinity percentage (Xc). The results provided in Table 5 demonstrate that there are no significant differences in the crystalline structure.

TABLE 5

| Sample | Tm, max (° C.) | ΔH (J/g) | Xc |
|---|---|---|---|
| Sample 8 | 222.2 | 24.8 | 34 |
| Sample 9 | 221.9 | 28.0 | 39 |
| Sample 10 | 225.6 | 26.5 | 37 |

### Example 7

Table 6 demonstrates how individual PC₁ and PBT layer thickness can affect flex-life performance. Sample 16 (500 micrometer total thickness) comprises three layers; two outer PC₁ layers (50 micrometers each) and a central PBT layer (400 micrometers). Multilayer PC/PBT Sample 12 (also 500 micrometer total thickness) was prepared in accordance with the present disclosure. Multilayer Sample 12 exhibits significantly higher flex-life than Sample 16 despite both samples containing the same materials and having the same total thickness. Accordingly, Table 6 demonstrates that the unique multilayer approach results in significant and unexpected flex-life improvements.

TABLE 6

| | | Thickness | Layer | Flex-life |
|---|---|---|---|---|
| Sample | Description | (micrometers) | thickness | Cycles |
| 11 | 64 multilayer 1:1 | 249 | 3.9 | DNF* |
| | PC₁/PBT | | | |
| 12 | 512 multilayer 1:1 | 500 | 0.98 | DNF* |
| | PC₁/PBT | | | |
| 13 | 64 multilayer 1:1 | 400 | 6.25 | DNF* |
| | PC₁/PBT | | | |
| 14 | 64 multilayer 1:1 | 600 | 4.69 | 85,000 |
| | PC₁/PBT + | | | |
| | 300 micrometer | | | |
| | PC₁ layer | | | |
| 15 | 64 multilayer 1:1 | 800 | 12.5 | 5,000 |
| | PC₁/PBT | | | |
| 16 | PC₁/PBT/PC₁ | 500 | 50 PC | 400,000 |
| | | | 400 PBT | |
| 17 | 2 × (64 multilayer 1:1 | 498 | 3.9 | 350,000 |
| | PC₁/PBT) | | | |

*DNF is did not fail; tested for 1 million flex-life cycles.

### Example 8

Tear propagation resistance tests were conducted for the purposes of this example. The tests were performed in accordance with ASTM D1938 (1992). The results are an average of 10 tests; 5 each in the flow direction and the cross flow direction. The samples were a single-layer PC₂ extruded film, PBT extruded film, PET extruded film, a 64 and a 512 multilayer 1:1 PC₂/PBT extruded film, and a 64 and a 512 multilayer 1:1 PC₂/PET extruded film. All samples had a total thickness of 100 micrometers. Table 7 demonstrates a synergy between polycarbonate and PET. The PC/PET had a very high tear strength as compared to the other materials. The tear strength for the PC/PET was greater than 15N, and even up to 35 N.

TABLE 7
Tear propagation data

| | Tear propagation strength |
|---|---|
| Material | [N] |
| PC₂ | 0.19 |
| PBT | 4.69 |
| PET | 3.60 |
| 64 multilayer 1:1 PC₂/PBT | 22.71 |
| 64 multilayer 1:1 PC₂/PET | 34.54 |
| PC₂/PBT blend (1:1 weight ratio) | 2.61 |
| 512 multilayer 1:1 PC₂/PBT | 9.59 |
| 512 multilayer 1:1 PC₂/PET | 31.65 |

### Example 11

Tests were conducted comparing conventional monolayer films with multilayer films. Film thickness was measured in micrometers (μm). The samples were tested for three characteristics: light transmissivity (Tr), thermoformability, and water vapor transmission rate (WVTR) as determined in accordance with ASTM E96, gravimetric determination of water vapor transmission. Thermoformability of the samples was tested according to the Niebling high pressure forming process at temperatures from 135° C. to 185° C. The temperature was adjusted within this range, for each sample, in an attempt to successfully thermoform. Thermoformability was determined based upon visual inspection using the unaided eye (without magnification). A thermoformable sheet has no cracking, tearing, or folding, when thermoformed (e.g., at a temperature of 135° C. to 185° C.) to a mold having at least one three dimensional feature with a 1 mm radius. WVTR was measured in grams per cubic centimeters per day (g/cc/day). The results are provided in Table 8.

TABLE 8

| | | Thickness | Tr | | WVTR |
|---|---|---|---|---|---|
| Sample | Description | (μm) | (%) | Thermoformable | (g/cc/day) |
| 18 | Monolayer PC₂ | 100 | 92 | Yes | 11.5 |
| 19 | Monolayer PCT | 150 | 92 | Yes | 7.1 |
| 20 | Monolayer PET | 125 | 90 | No | 1.7 |
| 21 | Monolayer PBT | 500 | 10 | Yes | 1.5 |
| 22 | 64 multilayer 1:1 PC₂/PBT | 200 | 90 | Yes | 1.6 |
| 23 | 512 multilayer 1:1 | 200 | 82 | Yes | 2.6 |
| | PC₂/PBT | | | | |
| 24 | 64 multilayer 1:1 PC₂/PBT | 100 | 78 | Yes | 3.4 |
| 25 | 512 multilayer 1:1 | 100 | 85 | Yes | 7.4 |
| | PC₂/PBT | | | | |
| 26 | 512 multilayer 1:1 | 100 | 85 | Yes | 7.4 |
| | PC₂/PET | | | | |
| 27 | 64 multilayer 1:1 PC₂/PET | 100 | 90 | Yes | 6.3 |

Table 8 demonstrates the surprising and advantageous characteristics of the multilayer substrates of the present disclosure. For example, sample 22 simultaneously possesses high transmissivity, thermoformability from 135° C. to 150° C., and a low WVTR. The multilayer substrates disclosed herein can have a WVTR of less than 10 g/cc/day, for example, less than or equal to 8 g/cc/day, or less than or equal to 5 g/cc/day, or less than or equal to 3.

Desirably, the multilayer substrate disclosed herein have a high transmissivity, e.g., greater than 70%, or greater than 80%. The multilayer substrate can also have a low WVTR, e.g., less than or equal to 10, e.g., less than or equal to 8, and even less than or equal to 5. The structure can also be thermoformed.

Set forth below are some embodiments of the articles (also referred to as structures).

### Embodiment 1

A multilayer structure, comprising: an outermost layer; a sensor; a multilayer substrate A located between the sensor and the outermost layer, the multilayer substrate A, comprising greater than or equal to 16 polymer A layers, preferably 16 to 512 polymer A layers; and greater than or equal to 16 polymer B layers, preferably 16 to 512 polymer B layers; wherein the polymer A layers and the polymer B layers are present in a ratio of 1:4 to 4:1, preferably the ratio is 1:1; optionally a back layer, wherein the sensor is between the back layer and the multilayer substrate A; wherein the multilayer substrate A has a transmission of greater than or equal to 70%, preferably greater than or equal to 75%, or greater than or equal to 80%; wherein the structure has a water vapor transmission rate of less than or equal to 10 g/cc/day, preferably less than or equal to 8 g/cc/day, or less than or equal to 5 g/cc/day, or less than or equal to 2 g/cc/day; and wherein at least one of: (i) the multilayer structure is thermoformable, preferably has no cracking, tearing, or folding, when thermoformed to a mold having at least one three dimensional feature with a 1 mm radius; and (ii) the multilayer structure is formable (e.g., thermoformable) without cracking, folding, or tearing with stretching at least an area of the multilayer structure by 50-80%.

### Embodiment 2

A multilayer structure, comprising: an outer layer having a transmission of greater than or equal to 70%; a substrate; electronics located between the outer layer and the substrate, preferably printed electronics; or printed electronics and surface mounted devices; wherein at least one of the outer layer and the substrate comprises a multilayer substrate A, and wherein the multilayer substrate A, comprising greater than or equal to 16 polymer A layers, preferably 16 to 512 polymer A layers; and greater than or equal to 16 polymer B layers, preferably 16 to 512 polymer B layers; wherein the polymer A layers and the polymer B layers are present in a ratio of 1:4 to 4:1, preferably the ratio is 1:1; wherein the multilayer substrate A has a transmission of greater than or equal to 70%, preferably greater than or equal to 75%, or greater than or equal to 80%; and wherein the multilayer substrate A has a water vapor transmission rate of less than or equal to 10 g/cc/day, preferably less than or equal to 8 g/cc/day, or less than or equal to 5 g/cc/day, or less than or equal to 2 g/cc/day.

### Embodiment 3

The multilayer substrate of Embodiment 2, wherein the electronics comprise a sensor.

### Embodiment 4

The multilayer structure of any of the preceding Embodiments, further comprising a multilayer substrate B, wherein the sensor is between multilayer substrate A and multilayer substrate B.

### Embodiment 5

The multilayer structure of Embodiment 4, further comprising an optically clear adhesive located between the multilayer substrate B and the multilayer substrate A.

### Embodiment 6

The multilayer structure of any of the preceding Embodiments, further comprising a haptic feedback actuator, wherein the multilayer substrate A is located between the outer layer and the haptic feedback actuator.

### Embodiment 7

The multilayer structure of any of the preceding Embodiments, further comprising a decorative layer located between the outermost layer and the multilayer substrate A.

### Embodiment 8

The multilayer structure of any of the preceding Embodiments, further comprising a light adjusting layer, wherein the sensor is between the multilayer substrate A and the light adjusting layer.

### Embodiment 9

The multilayer structure of any of the preceding Embodiments, wherein the polymer A layers comprise at least one of polycarbonate, polyimide, polyarylate, polysulphone, polymethylmethacrylate, polyvinylchloride, acrylonitrile butadiene styrene, and polystyrene; preferably polymer A layers comprise polycarbonate; preferably polymer A layers comprise a polycarbonate copolymer.

### Embodiment 10

The multilayer structure of any of the preceding Embodiments, wherein the polymer B layers comprise at least one of polybutylene terephthalate, polyethylene terephthalate, polyetheretherketone, polytetrafluoroethylene, polyamide, polyphenylene sulphide, polyoxymethylene, and polypropylene; preferably wherein the polymer B layers comprise at least one of polybutylene terephthalate and polyethylene terephthalate; preferably wherein the polymer B layers comprise polyethylene terephthalate.

### Embodiment 11

The multilayer structure of any of the preceding Embodiments, wherein the total number of substrate layers is 32 to 1024, preferably 64 to 512.

### Embodiment 12

The multilayer structure of any of the preceding Embodiments, wherein the overall thickness of the multilayer substrate A is less than or equal to 4 mm, preferably less than or equal to 2 mm, or less than or equal to 1 mm.

### Embodiment 13

The multilayer structure of any of the preceding Embodiments, further comprising at least one of a light emitting diode, a sensor; preferably, at least one of a switch, a controller, a camera, and a transducer.

### Embodiment 14

The multilayer structure of any of the preceding Embodiments, the multilayer structure is thermoformable, preferably is thermoformable without visible cracking, tearing, or folding, when thermoformed to a mold having at least one three dimensional feature with a 1 mm radius, preferably the multilayer substrate is thermoformable at a temperature of 135° C. to 185° C.

### Embodiment 15

The multilayer structure of any of the preceding Embodiments, wherein the multilayer structure is free of separable cover components and/or separable mechanical connective components; or wherein any cover components and/or any mechanical connective components cannot be separated from the multilayer structure without damage to the structure.

### Embodiment 16

The multilayer structure of any of the preceding Embodiments, wherein the multilayer structure is thermoformable without visible cracking, folding, or tearing, after stretching at least an area of the multilayer structure by 50-80%, preferably the thermoforming is at a temperature of 135° C. to 185° C.

### Embodiment 17

The multilayer structure of any of the preceding Embodiments, wherein the multilayer structure is at least a portion of a dashboard of a vehicle.

### Embodiment 18

The multilayer structure of any of the preceding Embodiments, further comprising a display.

### Embodiment 19

The multilayer structure of any of the preceding Embodiments, wherein the multilayer structure is a touch screen display, or a button.

### Embodiment 20

The multilayer substrate of Embodiment 19, wherein the multilayer substrate is a contactless button.

### Embodiment 21

The multilayer structure of any of the preceding Embodiments, wherein the multilayer substrate has a tear strength of greater than 15N, preferably greater than or equal to 20N, or greater than or equal to 25N, as determined in accordance with ASTM D1938 (1992).

### Embodiment 22

The multilayer structure of any of the preceding Embodiments, wherein the multilayer substrate a flex-life of the multilayer identity article is greater than or equal to 400,000 cycles, preferably greater than or equal to 500,000 cycles, preferably greater than or equal to 600,000 cycles, as determined according the standards found in ISO/IEC 24789-2:2011.

### Embodiment 23

The multilayer structure of any of the preceding Embodiments, wherein the polymer A layers comprises a copolymer of polycarbonate and sebacic acid.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The identifiers “A” and “B” are merely used to distinguish one element from another element. They are merely for clarity. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless clearly specified otherwise, all standards are the most recent version available as of Jul. 1, 2016.

As used herein, cracking, tearing, and folding, were determined by visual inspection using the unaided eye (without magnification), and having normal (e.g. 20/20) vision.

“Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference. This application claims priority to U.S. Ser. No. 62/365,052 filed on Jul. 21, 2016, which is incorporated herein in its entirety.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A multilayer structure, comprising:
an outermost layer;
a sensor;
a multilayer substrate A located between the sensor and the outermost layer, the multilayer substrate A, comprising
greater than or equal to 16 polymer A layers; and
greater than or equal to 16 polymer B layers;
wherein the polymer A layers and the polymer B layers are present in a ratio of 1:4 to 4:1;
wherein the multilayer substrate A has a transmission of greater than or equal to 70%;
a back layer, wherein the sensor is between the back layer and the multilayer substrate A;
wherein the multilayer structure has a water vapor transmission rate of less than or equal to 10 g/cc/day; and
wherein at least one of:
(i) the multilayer structure is thermoformable, when thermoformed to a mold having at least one three dimensional feature with a 1 mm radius; and
(ii) the multilayer structure is formable without visible cracking, folding, or tearing, after stretching at least an area of the multilayer structure by 50-80%.

2. A multilayer structure, comprising:
an outer layer having a transmission of greater than or equal to 70%;
a substrate;
electronics located between the outer layer and the substrate; or printed electronics and surface mounted devices;
wherein at least one of the outer layer and the substrate comprises a multilayer substrate A, the multilayer substrate A, comprising
greater than or equal to 16 polymer A layers; and
greater than or equal to 16 polymer B layers;
wherein the polymer A layers and the polymer B layers are present in a ratio of 1:4 to 4:1;
wherein the multilayer substrate A has a transmission of greater than or equal to 70%; and
wherein the multilayer structure has a water vapor transmission rate of less than or equal to 10 g/cc/day.

3. The multilayer structure of claim 2, wherein the electronics comprise a sensor.

4. The multilayer structure of claim 1, further comprising a multilayer substrate B, wherein the sensor is between multilayer substrate A and multilayer substrate B.

5. The multilayer structure of claim 4, further comprising an optically clear adhesive located between the multilayer substrate B and the multilayer substrate A.

6. The multilayer structure of claim 1, further comprising a haptic feedback actuator, wherein the multilayer substrate A is located between the outer layer and the haptic feedback actuator.

7. The multilayer structure of claim 1, further comprising a decorative layer located between the outermost layer and the multilayer substrate A.

8. The multilayer structure of claim 1, further comprising a light adjusting layer, wherein the sensor is between the multilayer substrate A and the light adjusting layer.

9. The multilayer structure of claim 1, wherein the polymer A layers comprise at least one of polycarbonate, polyimide, polyarylate, polysulphone, polymethylmethacrylate, polyvinylchloride, acrylonitrile butadiene styrene, and polystyrene.

10. The multilayer structure of claim 1, wherein the polymer B layers comprise at least one of polybutylene terephthalate, polyethylene terephthalate, polyetheretherketone, polytetrafluoroethylene, polyamide, polyphenylene sulphide, polyoxymethylene, and polypropylene.

11. The multilayer structure of claim 1, wherein the total number of substrate layers is 32 to 1024; and preferably wherein the overall thickness of the substrate is less than or equal to 4 mm.

12. The multilayer structure of claim 1, further comprising at least one of a light emitting diode, a sensor.

13. The multilayer structure of claim 1, wherein the multilayer structure is free of separable cover components and/or separable mechanical connective components; or wherein any cover components and/or any mechanical connective components cannot be separated from the multilayer structure without damage to the structure.

14. The multilayer structure of claim 1, wherein the multilayer structure is formable without visible cracking, folding, or tearing, after stretching at least an area of the multilayer structure by 50-80%.

15. The multilayer structure of claim 1, further comprising a display.

16. The multilayer structure of claim 1, wherein the multilayer structure is a touch screen display, or a button.

17. The multilayer structure of claim 17, wherein the multilayer structure is a contactless button.

18. The multilayer structure claim 1, wherein the multilayer substrate has a tear strength of greater than 15 N, as determined in accordance with ASTM D1938 (1992).

19. The multilayer structure of claim 1, wherein the multilayer substrate a flex-life of the multilayer identity article is greater than or equal to 400,000 cycles, as determined according the standards found in ISO/IEC 24789-2:2011.

20. The multilayer structure of claim 10, wherein the polymer B layers comprise at least one of polybutylene terephthalate and polyethylene terephthalate.
